(19) United States
(12) Patent Application Publication
(10) Pub. No.: US 2026/0218511 A1
(43) Pub. Date: Jul. 30, 2026

(54) ROBUST VACUUM INSULATION PANEL WITH MECHANICAL SUPPORTS

(71) Applicant: Alan Feinerman, Skokie, IL (US)

(72) Inventor: Alan Feinerman, Skokie, IL (US)

(73) Assignee: Cleaner Slate, LLC, Skokie, IL (US)

(21) Appl. No.: 19/038,395

(22) Filed: Jan. 27, 2025

(51) Int. Cl. E04B 1/80; B21D 28/02

(52) U.S. Cl. CPC E04B 1/803; B21D 28/02

(57) ABSTRACT

A robust vacuum insulation panel having a top foil and a bottom foil. The top and bottom foils are spaced apart a predetermined distance, and a core comprising an array of mechanical supports is disposed between the top and bottom foils. The array of mechanical supports are configured to provide a heat conductivity path between the top foil and the bottom foil. The heat conductivity path is greater than the predetermined distance between the top and bottom foils.

### FIELD OF THE INVENTION

A method and an apparatus for robust vacuum insulation panels (“VIPs”) with mechanical supports.

### Problem to be Solved

Currently, there is an industry need to create more effective, less expensive, more robust, and thinner thermal insulation. VIPs can have the same thermal insulation value as still-air insulation but can be considerably more compact. VIPs comprise top, bottom, and edge foils with enclosures inside the foils that have been nearly completely evacuated of gases and therefore must support at a minimum an atmospheric load of ~14.7 pounds or ~0.101 MPa. The enclosure contains the mechanical supports of the VIP. To operate under reduced pressure, the enclosure of the VIP must be hermetic since any leaks will increase the internal pressure over time, reducing the effectiveness of the VIP. Any significant pressure increase inside the VIP will decrease its thermal insulation value. Surfaces and components inside the enclosure must minimize any substances that can volatize, otherwise this will also cause the internal pressure to increase over time. The edge foil around the VIP needs to minimize the heat flow through it, otherwise the heat leaks around the perimeter of the VIP will degrade its overall thermal performance. Current VIPs are fragile and cannot withstand temperatures significantly over ~100° C. This fragility and low maximum temperature limit the VIP's application.

Thus, it would be advantageous to improve upon the following characteristics of VIPs; strength, robustness, maximum temperature, heat leaks about the perimeter, and their cost. By doing so VIPs could be used in applications which they currently cannot, such as in high temperature applications. The method and apparatus of the invention described within this application improves upon all characteristics listed above.

### DESCRIPTION OF PRIOR ART

All known prior art references are publications related to the manufacturing of VIPs and the structure of traditional VIPs. Applicant's previously issued U.S. Pat. No. 9,157,230 describes a method to produce traditional VIPs. In the disclosure of this patent, the VIP can be comprised of at least two pieces of thin foil welded together with a thin metal foil material defining the edge of a sealed gas evacuated enclosure. There is a VIP core between at least two pieces of welded thin metal foil, glass, and/or ceramic material. The VIP core is located inside the sealed and gas evacuated vacuum enclosure.

Although the prior art describes a traditional way to form a traditional VIP, these disclosures do not contain the structure of the invention presently disclosed. Current VIPs use a core composed of fumed silica (glass produced by pyrolysis of SiCl₄) or glass fibers. Fumed silica has a density of 150-200 kg/m³. Glass fibers have a density of 220-280 kg/m³. The VIP structure presented here has the potential to have a density less than this by at least an order of magnitude. Current VIPs are enclosed in a multilayer of metallized polymer films. A typical envelope has multiple layers of ~100-micron thick polymer film covered with ~0.1-micron thick aluminum film. The thermal conductivity of the polymer film is typically ~0.1 watt/(m*K) and the thermal conductivity of aluminum is typically ~240 watt/(m*K). These enclosures minimize the heat leaks around the perimeter of the VIP but are easily punctured or scratched and cannot withstand temperatures significantly over ~100° C. The prior art fails to produce a VIP that is both more puncture resistant and can tolerate temperatures over about 100 degrees C., while being cost effective.

### Object of the Invention

The present invention provides a method and apparatus for robust vacuum insulation panels (“VIPs”) with mechanical supports. The apparatus of this invention provides foil mechanical supports of various configurations and arrays between top and bottom foils, along with a unique seal about the VIP's perimeter. The foils used for the mechanical supports and the foil used to seal about the mechanical supports can vary. These configuration improvements of the present invention improve the robustness of the VIP and the temperature range over which its application is effective. These improvements allow the present invention to be used in a variety of additional applications, while being cost effective to produce.

### SUMMARY OF THE INVENTION

The invention disclosed in this application in one embodiment is a robust vacuum insulation panel (VIP) with mechanical supports. The VIP can have a top and a bottom foil where each has an inner and an outer surface, the inner surfaces of the top and bottom foils are connected to a core via various methods such as but not limited to welding or brazing. Also, the core can be just placed between the top and bottom foils. The core itself consists of an array of mechanical supports; the array of mechanical supports configured to support at a minimum the atmospheric pressure load applied to the vacuum insulation panel. The supports can increase the length of the heat path between the top and bottom foils beyond the distance separating the top and bottom foils to increase the thermal insulation value of the VIP. The heat path is increased by interposing a tensile element between compressive elements, which forces the conductive component of heat transfer to flow up one compressive element, down the interposing tensile element, and then up the following compressive element. The heat path can be lengthened with additional tensile elements as long as economically justified. There is a thin exterior foil that wraps about the edge of the VIP. The thin exterior foil is hermetically connected to the top and the bottom foil to form a complete vacuum insulation panel.

### BRIEF DESCRIPTION OF DRAWINGS

FIG. 1 is a front perspective view of an embodiment of a mechanical VIP support structure comprising an outer corrugated hexagon supporting an inner corrugated hexagon, where the tensile elements interposed between the hexagons are not shown for visual clarity.

FIGS. 2A, B, and C are schematic cross-section views of three separate VIP support structures.

FIGS. 3A and B are schematic top plan views of two punch out designs for nested square support columns.

FIGS. 4A and B are schematic top plan views of two punch out structures for nested square supports columns with planar tensile elements.

FIG. 4C is a cross section of an inner square compressive element with folded excess material.

FIG. 5A is a schematic top plan view of an array of nested punch out structures with gray and black connection strips.

FIG. 5B is a schematic top plan view of a punch out structure for nested square columns with three columns and two connected interposed tensile elements.

FIG. 6 is a perspective view of a VIP with the top foil deformed to fit over the core and connect to the bottom foil.

FIG. 7A is a perspective view of the top and bottom foils of the VIP with shallow trays.

FIG. 7B is a cross-sectional view of the edge of the VIP with corrugations between the top and bottom foil.

FIG. 7C is a top plan view of a VIP with the top foil removed, illustrating an embodiment of a core of a VIP.

FIG. 7D is an elevation schematic side view of the VIP with corrugations between the top and bottom foils with a mechanical support and black body radiation shields.

FIG. 7E is an elevation schematic side view of the VIP with a ceramic top surface to withstand very high temperatures in an oxidizing ambient.

FIG. 7F is an elevation schematic side view of a transparent VIP with two glass panes separated by a support that folds the heat path.

FIG. 8A is an elevation schematic side view of a VIP with a corrugated thinner foil around the edge of the VIP.

FIG. 8B is a schematic view of and embodiment of a VIP with two arrays of small VIP tiles tethered together to form a VIP for an elastic suit.

FIG. 9 is a perspective exploded view of a VIP severed punch out structure in an unassembled form.

FIG. 10 is a perspective exploded view of a VIP severed punch out structure receiving a first set of folds.

FIG. 11 is a perspective exploded view of a VIP severed punch out structure receiving a second set of folds.

FIG. 12 is a perspective exploded view of a VIP severed punch out structure receiving a third set of folds.

FIG. 13A is a perspective exploded view of a VIP severed punch out structure receiving a final set of folds.

FIG. 13B is a lateral perspective view of a VIP severed punch out structure receiving a final set of folds.

### DETAILED DESCRIPTION OF THE ILLUSTRATED EMBODIMENTS

In one embodiment, the mechanical VIP support structures are made from metal foil that can support at a minimum the external atmospheric pressure. The mechanical supports make up the core of the VIP in this embodiment. The foils used to create the mechanical supports can vary and can include but are not limited to Ti8Al1Mo1V, 316 stainless steel, and FeCrAl alloy. The maximum temperature for a VIP with a metal envelope in an oxidizing atmosphere is ~1300° C. when using a FeCrAl alloy. Higher temperatures in an oxidizing atmosphere can be reached if a ceramic like Yttria-stabilized zirconia (YSZ) replaces the metal foil where it is exposed to temperatures over what the metal foil can tolerate. The ceramic edge would need to be metallized to join to a metal foil as will be described later. Corrugations in the ceramic could be necessary wherever it will be exposed to a temperature gradient that causes excessive stress. Ultimately any foil that provides satisfactory thermal and mechanical performance of the core at an economically justifiable cost can be used. The thermal performance of the core is determined by the quantity

$$\frac{{κ}_{Air} * {σ}_{S}}{{κ}_{S} * atm}$$

where κ_{Air} and κ_{S} are the thermal conductivities of still air and the support material respectively, σₛ is the allowable compressive or tensile stress the support can withstand and “atm” is ~0.101 MPa. A particularly good choice of support would be the alloy Ti8Al1Mo1V which has a reported thermal conductivity of 6.0 watt/(m*K), a tensile yield strength of 930 MPa, and a compressive yield strength of 980 MPa. Assuming a working compressive or tensile stress of 300 MPa and no other heat losses through molecular transport, black body radiation, or edge losses, the VIP would have a thermal insulation value of

$$\frac{0.029 * 300}{6 * 0.101} = 14$$

times the same thickness as still air insulation. Support materials can include, but are not limited to titanium alloy, stainless steel, and FeCrAl alloy. In these three limited examples, κₛ, would be equal to κ_{Ti}, κ_{SS}, and κ_{FeCrAl} respectively.

The VIPs themselves and the mechanical supports could be constructed of various materials. A less expensive choice of support would be 316 stainless steel which has a reported thermal conductivity of 16 watt/(m*K), a tensile strength of 480 to 620 MPa, and a compressive yield strength of 170 to 310 MPa. Assuming a working compressive or tensile stress of 200 MPa and no other heat losses, the VIP using 316 stainless steel supports, would have a thermal insulation value of

$$\frac{0.0 \; 29 * 200}{16 * 0.101} = 3.6$$

times the same thickness as still air insulation. Since there are other heat losses and 3.6 times is not a huge improvement over still air insulation, the thermal conduction through the support can be reduced by folding the heat path through the VIP.

Making the heat path between the bottom and top foils of the VIP longer than the thickness of the VIP increases the thermal insulation improvement by the resulting ratio. This can be accomplished by designing a supporting structure that has a compressive support element followed by a tensile element followed by a compressive element, or a compressive support element followed by a tensile element followed by a compressive element followed by a tensile element followed by a compressive element, etcetera. These compressive and tensile elements would extend through most of the thickness of the VIP between the top and bottom foils with just the first and last compressive elements making contact with the internal surface of the bottom and top foils of the VIP respectively.

These mechanical support structures consist of an integer number N of compressive elements and N−1 number of tensile elements connecting the columns within the core of the VIP. N can be one, two or more, but two or three is usually the maximum required for adequate insulation. These columns can have a cross-section of an equilateral triangle, square, pentagon, hexagon, heptagon, octagon, and even more sides or ultimately round. The larger the cross-sectional area required to achieve a given area moment of inertia, the greater the heat flow. The most efficient cross-sectional shape is a circle since all the mass has the same distance from the axis of the column. On the condition that the foil thickness of the mechanical support is much thinner than the column's radius of gyration, a triangular column has ~11% more mass than a circular column, a square column ~7% more mass, a hexagonal column ~3% more mass, and an octagonal column ~2% more mass.

The mechanical supports that create the columns can be “punched” from a foil sheet. The punch out pattern for different shapes, such as a square or a hexagon, will vary. The material used to make a column can be minimized by punching holes into the column as long as it remains mechanically stable. Removing material that is closer to the column's axis of symmetry will minimize the reduction in the column's area moment of inertia and will increase the thermal resistance so that the outer compressive element has a similar thermal resistance as the inner column's thermal resistance. Columns do not have to be symmetric and could have, for example a U channel cross section. It is expected that symmetric columns that have a closed figure cross-section, such as an equilateral triangle, will be more mechanically stable than an open structure like a “U” or “right angle” channel. In some embodiments these columns can be corrugated. These corrugations increase the compressive load a column can carry before buckling. The tensile element width must be sufficient to support the tensile load without significant creeping or any tearing. The thermal performance of the core is increased if the compressive and tensile elements each support the maximum stress, they can withstand without failing during the lifetime of the VIP. The width of the tensile element can be increased at its ends to spread out the stress where it attaches to a compressive element.

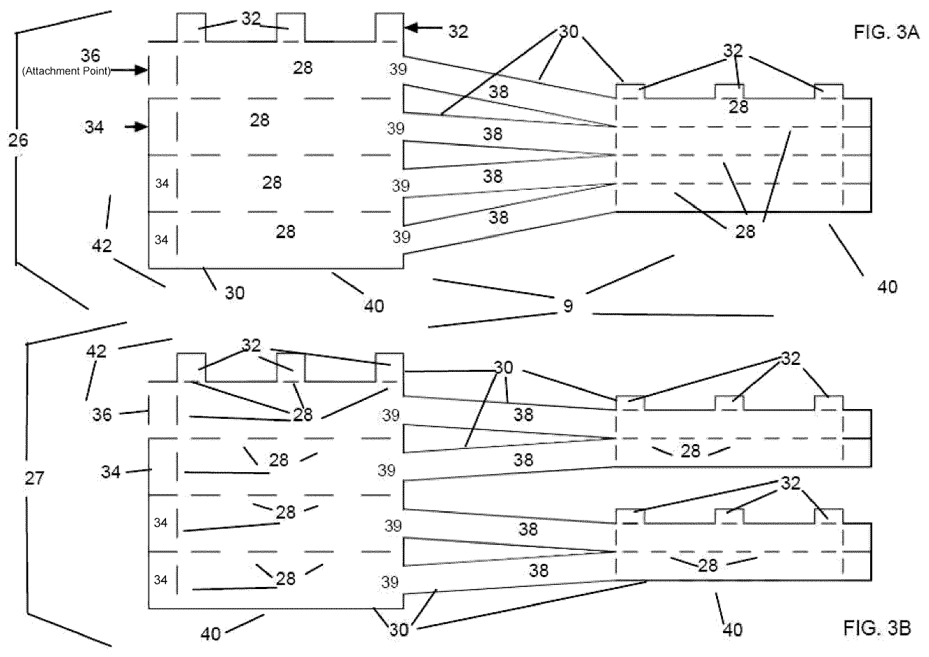

The compressive support elements need to be assembled from the punch out pattern. Choices for creating a closed column cross-section from a planar cutout include welding, brazing, adhesive, crimping, riveting, etc. Two advantages of welding are that it will not reduce the maximum temperature the VIP can withstand, and it will not be a source for molecules that can volatize such as an adhesive. The welding tabs should be preferably discontinuous, as shown in FIGS. 3A and 3B, to minimize their contribution to the heat flow along the axis of the column.

Surrounding the core of the VIP is its envelope comprising a top, bottom, and edge foil. The top and bottom foils of the VIP must support atmospheric pressure. These top and bottom foils can be made from metal foils such as, but not limited to, titanium, stainless steel, FeCrAl alloy, and possibly aluminum. The maximum stress in the top and bottom foils will be where the internal surfaces of each foil contacts the top and bottom of the mechanical support elements. This stress will be minimized if the support elements are arranged in a square or a honeycomb pattern instead of a rectangular pattern where the supports might be much further apart in one direction than in an orthogonal direction.

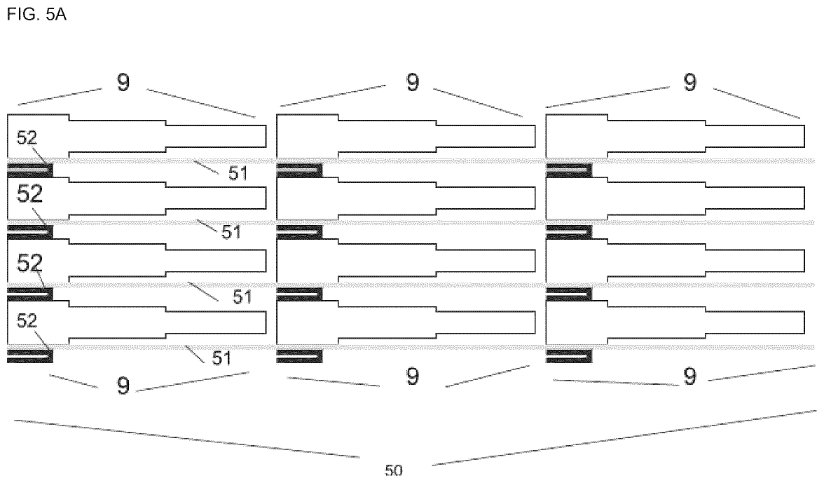

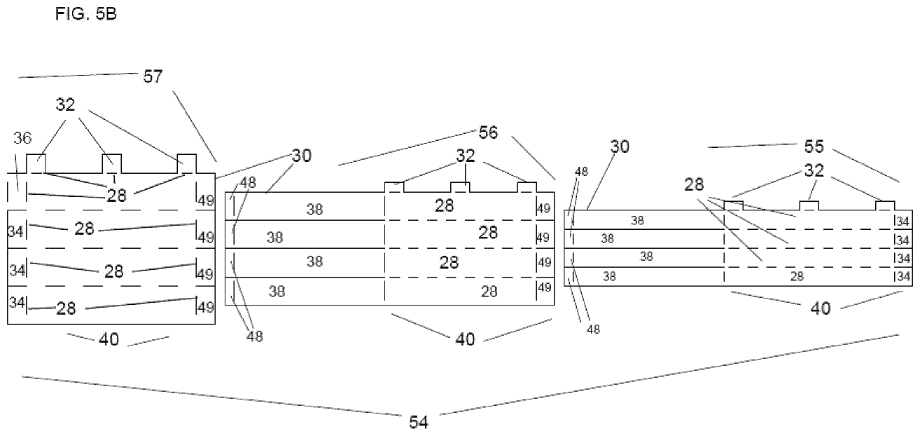

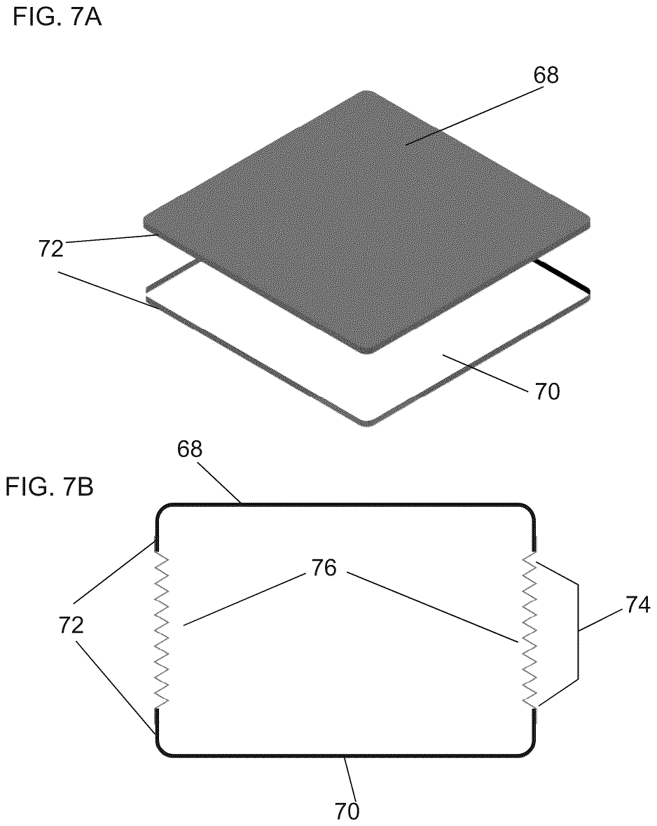

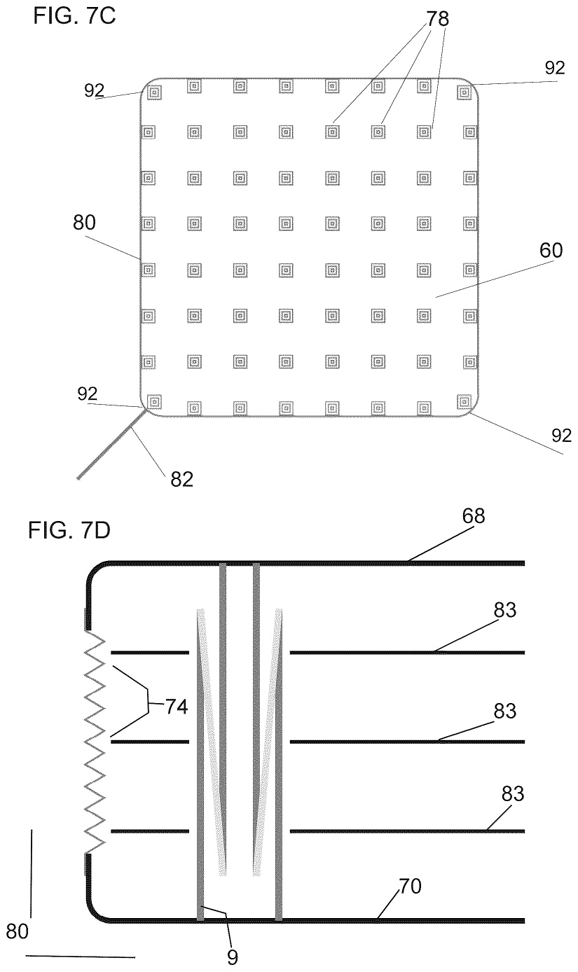

In one embodiment, the punch out pattern of the mechanical supports can have linkages that can be contracted and/or expanded as necessary to achieve a more uniform pattern of support elements. This has the virtue of allowing all the supports to be fabricated simultaneously and placed in their desired final locations as a single unit. It would be possible to make a supply of supports and then place them individually or in a row or a column at a time, but the fastest manufacturing method is typically achieved by processing as many items as possible in parallel. As an example, vacuum glazing (transparent VIPs) typically uses an array of short stainless-steel cylinders to support the atmospheric load. An array of folded supports would have a lower thermal conduction through the folded mechanical supports than an array of stainless-steel cylinders and can be placed in the vacuum glazing as a single item. This embodiment is visually illustrated in FIGS. 5A and 7C.

A typical assembly procedure for forming the array of support elements illustrated in FIG. 5B from a flat foil starts with a two-stage press that squeezes the foil to form the necessary corrugations, and then severs the foil where necessary. A laser can also be used to sever the foil. There are optional stress tabs in the pattern that spread out stress or can reinforce where tensile elements will be attached to compressive elements. The tabs connected to the compressive elements would be bent down and the tabs connected to the tensile elements would be bent up. A conducting rod of the appropriate cross-section would be placed over the punched foil. An actuator would come up from below the foil and wrap the foil around the lower half of the conducting rod. A second actuator would pinch the top part of the foil together over the conducting rod. Alternatively for square columns an actuator presses the foil against the top half of the conducting rod and then presses the weld tabs down along the edge of the column. If the columns have 6 or more sides the actuator has to reverse its initial direction to press the weld tabs down against the foil. The weld tabs would then be attached to make the closed cross-sectional support, such as by spot welding, but other methods can be used. After the conducting rod is removed, a smaller conducting rod would be placed over the foil of the appropriate cross-section for the middle compressive support and the above process repeated. The inner compressive support would then be assembled with a still smaller conducting rod. If a rod of varying cross-sections is used, only a row or a column of the array can be processed at a time.

The outer compressive element would be then rotated 90 degrees, so it is perpendicular to the foil's plane and moved so the outer compressive element rested on the tab that attaches the outer compressive element to the foil. One or more of the other weld tabs at the bottom of the compressive element are attached to the foil, preferably by spot welding but other methods can be used. The middle compressive support and tensile elements are removed from the remaining foil and placed inside the outer compressive element, and all the connecting weld tabs are then attached together. The inner compressive support and tensile elements would be removed from the remaining foil and placed inside the middle compressive element and all the connecting tabs would be attached together. The foil material on the outside of the VIP and the foil material utilized for the mechanical supports of the VIP can be different based on the application. The outer foil of the VIP should be the same material to prevent enhanced corrosion due to the formation of a galvanic couple.

In an alternative fabrication scheme after the array of outer columns are rotated 90 degrees and secured perpendicularly to the foil's plane the black body shields would then be placed around the outer column array. An array of middle columns and tensile elements can then be prepared from a second sheet, made perpendicular, and inserted as a single unit into the array of outer columns. After the middle tensile elements are securely attached to the outer columns an array of inner columns and tensile elements can then be prepared from a third sheet, made perpendicular, and inserted as a single unit into the array of middle columns. A virtue of this method is its speed of manufacture and it minimizes the amount of foil required to assemble a core with a folded heat path.

As mentioned above, the thermal conduction through the perimeter of the VIP panel should be minimized to increase the overall thermal performance. If the thermal conduction through a square VIP of size S_{VIP} and thickness t_{VIP} is

$${κ}_{VIP} * {S}_{VIP}^{2} * ∇ T$$

where κ_{VIP} represents the average thermal conduction through the VIP and

$$∇ T = \frac{{T}_{h o t} - {T}_{l o w}}{{t}_{VIP}}$$

is the temperature gradient across the VIP, the thermal conduction through the perimeter of the VIP is κ_{edge}*4*S_{VIP}*t_{edge}*∇T where κ_{edge} is the thermal conductivity through the edge of the VIP and t_{edge} is the thickness of the edge of the envelope between the top and bottom foils. If the size of the square VIP is

$${S}_{c r o s s} = 4 * \frac{{κ}_{e d g e}}{{κ}_{VIP}} * {t}_{edge}$$

then as much heat will flow through the area of the VIP as through its perimeter. The thermal performance of the VIP can be maximized if S_{VIP}>>S_{cross}.

The invention of this disclosure can utilize three different edge designs. In the first design or embodiment, the foil layer on the top is deformed. The top surface is preferably where the VIP is exposed to the higher temperature. The deformation brings the top and bottom foil surfaces together so they can be hermetically joined. The seal can be made by resistance or laser welding, or by brazing. If the top and bottom foils are made from 0.002 inch thick 316 stainless steel foil, if κ_{VIP}=0.0029 watt/(m*K), and if the foil doesn't thin significantly during the drawing operation, then S_{cross}~44 inches. The VIP can be brazed under vacuum or evacuated and sealed using the previous patented method disclosed in U.S. Pat. No. 9,157,230 B2.

In another embodiment, edge losses are reduced considerably. In this embodiment, the top and bottom foils are made into shallow trays with edges. A strip of much thinner foil is welded or brazed around the perimeter of the VIPs top and bottom foil. Corrugations in the strip of thin foil strengthen the edge and lengthen the heat path. Welding can withstand higher temperatures than brazing. If the thinner foil is made from 0.0002 inch thick 316 stainless steel foil, the effective heat path length is doubled, and assuming κ_{VIP}=0.0029 watt/(m*K), then S_{cross}~2 inches. If the foil wrapped around the edge has top and bottom edges coated with aluminum, it can be anodically bonded to two panes of glass to make a vacuum glazing with minimal edge losses. In general, it is difficult to get aluminum to adhere to stainless steel. If a thin adhesion layer such as chrome or titanium is deposited over the edges of the stainless-steel foil by evaporation and then without breaking vacuum a thin aluminum layer is deposited on the adhesion layer, the aluminum will adhere to the stainless-steel foil where it needs to be bonded to the glass pane. However, 316 stainless steel and aluminum are examples of a foil that can be used. Other foils can be applicable to use depending on the application of the VIPs, such as using FeCrAl alloy for higher temperature applications in an oxidizing ambient. If the VIP will be exposed to temperatures over ~1300° C. the top surface can be replaced with a ceramic and the core can be fabricated from Molybdenum, Niobium, Tantalum, or other refractory metal foil with a high melting point, and high ratio of allowable mechanical stress to thermal conductivity. If there is too much thermal conduction across the mechanical support array the heat path length can be increased by incorporating additional folds. The core will not oxidize since it's under vacuum.

The next embodiment takes a thinner foil and bends the edges about the core comprising mechanical supports. This structure is sealed under vacuum with a brazing or welding operation. The VIP can be sealed under vacuum or by evacuating the structure during the final seal. A getter is added to the VIP to capture any gas molecules that diffuse in or are volatized from inside the VIP. Regardless of which edge design, the best practice is to add a getter last, typically just prior to sealing. However, a getter can be added at other times throughout the process. This embodiment of edge sealing via the evacuation method can also use the disclosure of U.S. Pat. No. 9,157,230.

Prior to sealing surrounding core with both top and bottom foils, black body shields need to be placed inside the VIP. The shields need to be punched to fit over the array of supports. The shields should be corrugated to minimize the physical contact between the shields. The corrugations in successive black body shields should be orthogonal. If the separation between the top and bottom foils is referred to as the z direction, then two specific alternating patterns for corrugating the shields are x and then y or radially and then theta. The latter method would require repeating the centers of the radial and theta corrugations multiple times throughout the VIP. In addition to orthogonal corrugations in the black body shields, each shield should have a further deformation to determine where it will rest on the previous black body shield. These resting points are varied throughout the stack of shields to lengthen any heat paths through the VIP. The black body shields are preferably made from thin aluminum foil except when the VIP will be exposed to temperatures approaching or above the melting point of the aluminum.

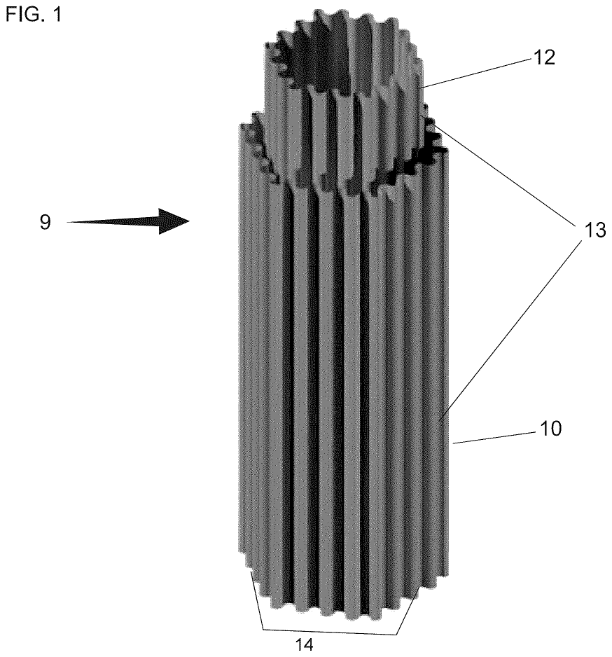

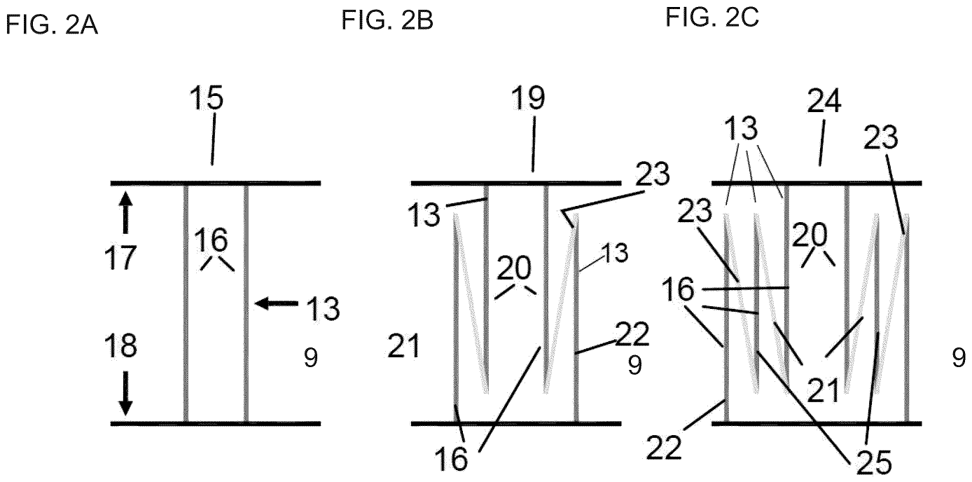

FIG. 1 is a perspective view of a single mechanical VIP support structure 9 comprising an outer corrugated hexagon 10 supporting an inner corrugated hexagon 12. These hexagons 10, 12 when installed between the top and bottom foils of a VIP form respectively both compressive columns 13 that support a portion of the atmospheric pressure upon the VIP. Corrugations 14 of each column 13 increase the compressive load that each column 13 can carry before buckling. Not shown in FIG. 1 are tensile elements that would connect the outer corrugated hexagon 10 and an inner corrugated hexagon 12 for visual clarity, but are illustrated in FIGS. 2B and 2C. The embodiment of FIG. 1 utilizes two columns 13 to construct the mechanical support 9 of the VIP but is not restricted to this number of support columns 13.

FIGS. 2A, B, and C are schematic cross-section views of three separate installed VIP support structures 9. In the first VIP support structure 15 (FIG. 2A), a plurality of spaced apart single support columns 13 form a plurality of hollow compressive elements 16 extending between and in contact with top foil 17 and bottom foil 18. Each support column 13 supports a portion of at least the atmospheric load on the VIP, applied to the top foil 17 and the bottom foil 18. At least one black body radiation shield 83 extends away and between the array of support columns 13. The black body radiation shields 83 reduce black body radiation across the VIP.

The second VIP support structure 19 (FIG. 2B) has two nested columns 13 each constructed from a compressive element 16 constituting an inner compressive element 20, a first tensile element 21 and an outer compressive element 22. The first tensile element 21 connects the inner and outer compressive elements 20, 22. This second VIP support structure 19 folds the heat path. As an example, if the outer compressive support element 22 has a height that is ⅞ the VIP thickness, the tensile element 21 has a length of ¾ the VIP thickness, and the inner compressive element 20 has a height that is ⅞ the VIP thickness, then the heat path is 2.5 times longer than the VIP thickness. If the elements of support structure 19 are made from 316 stainless steel under an average of 200 MPa of stress, then instead of an improvement of 3.6 times compared to a still air thermal insulator, the improvement is 3.6×2.5 or ~9 times better than the same thickness of a still air insulator.

The third VIP support structure 24 (FIG. 2C) has three nested columns 13 with an inner 20, outer 22, and middle compressive element 25. The bottom of the inner compressive element 20 is connected to the top of the middle compressive element 25 via a first tensile element 21. The bottom of the middle compressive element 25 is connected to the top of the outer compressive element 22 via a second tensile element 23. This third VIP support structure 24 again increases the heat path via folding of the mechanical supports 9 within the VIP.

FIGS. 3A and B are schematic top plan views of two punch out structures for supports 9 with nested square columns. There is a first punch out pattern 26 (FIG. 3A) and a second punch out pattern 27 (FIG. 3B). These punch out patterns are punched out of any suitable foil the user may desire and then assembled into three-dimensional support structures. Dashed lines 28 in FIGS. 3A and 3B represent where the punch out structures 26, 27 would be folded, and the solid lines 30 designate where the punch out structures 26, 27 would be separated from the original foil (not shown). Located about both punch out structures 26, 27 are weld tabs 32 and optional support/stress tabs 34 with an attachment point 36. The tensile elements 38 of the structures 26, 27 connect respectively to each of the sides 39 of the compressive elements 40. In this embodiment, the weld tabs 32 and optional support/stress tabs 34 with an attachment point 36 are found on both compressive elements 40 of the structures 26, 27 but can vary depending on the configuration of the punch-out. Upon folding the structures 26, 27 on the dashed lines 28, each structure would transform from a flat punch out to a three-dimensional nested mechanical support 9 as illustrated in FIGS. 1 and 2B. The weld tabs 32 would be welded to the opposite end of the compressive element 40. There should be a weld tab 32 at the top, middle, and bottom of each compressive element 40 and more if needed. Additional weld tabs strengthen the column against buckling but decrease the column's thermal resistance. The optional support/stress tabs 34 can be folded over to distribute the stress of the column 13 on the top and bottom foils of the VIP (not shown) over a wider area. The attachment point 36 is where the column 13 (FIG. 1) will remain attached after it is folded back over the indicated tab.

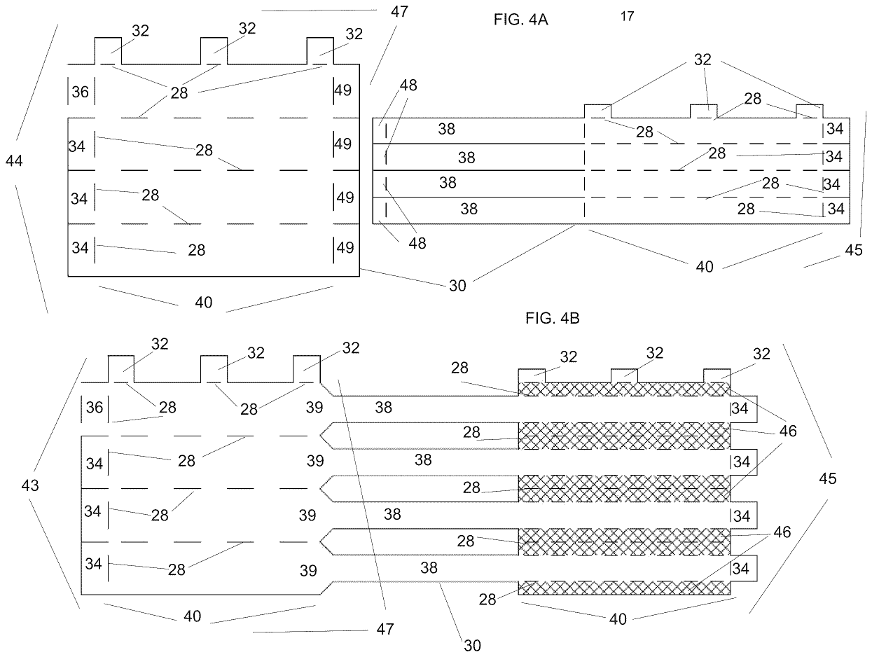

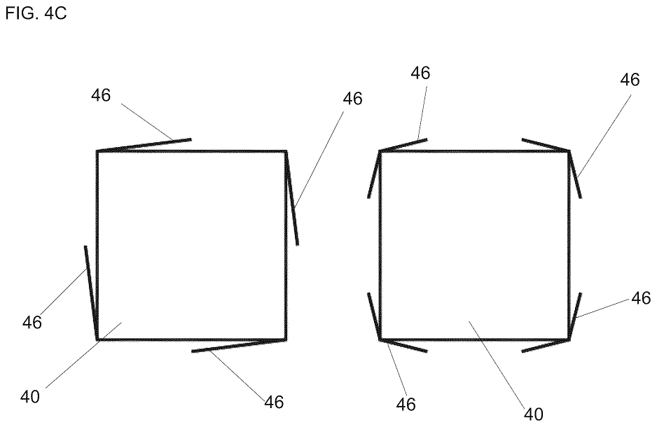

FIGS. 4A and 4B are schematic top plan views of two punch out structures for fabricating nested square columns with planar tensile elements. Punch out structures 43, 44 (FIGS. 4A and 4B) are similar to that of punch out structures 26, 27 (FIGS. 3A and 3B), but differ primarily that punch out structures 43, 44 have tensile elements 38 that are planar upon assembly. As explained in regard to FIGS. 3A and B, the dashed lines 28 are where the support structures 43, 44 are folded and the solid lines 30 are where the support structures 43, 44 are completely severed from the original foil (not shown). Punch out designs 43, 44 have weld tabs 32 and optional support/stress tabs 34 with an attachment point 36 that are found on both compressive elements 40 as explained with regard to the embodiments of FIGS. 3A and B. In punch out support structure 43 after the inner column 45 is assembled, the tensile elements 38 are connected via a connection tab 48 over the top of the outer column at a connection area 49 attaching to the outer column 47. The connection tab 48 and connection area 39 can be connected via welding, brazing, or any other process known within the art. Not shown are small tethers that keep the components from separating from the remaining foil until assembly. These tethers are not needed if the inner columns are made from a separate sheet and have their own attachment point connecting them to the sheet. Punch out support 44 creates a smaller inner column 45 (FIG. 4B) by bringing the crossed hatch material 46 (shown in FIGS. 4B and 4C) together to create a smaller inner column 45 that will fit inside the outer column 47. FIG. 4C shows two possible methods of taking up the excess material, the cross-hatched material 46.

FIG. 4C is a cross section of a folded compressive 40 element with folded excess material, shown as the cross-hatched material 46 in FIG. 4B. When folding upon the dashed lines 28 (not shown in this figure) the excess cross-hatched material 46 in this embodiment needs to be folded over itself at the corners. This is necessary to form the structure in FIG. 4B as the inner column 45 must be smaller than the outer column 47 to fit within it.

FIG. 5A is a schematic top plan view of an array of folded punch out structures 50 illustrated with gray 51 and black connection strips 52. The folded punch out structures 50 show individual mechanical supports 9 connected left to right by gray connecting strips 51, and connected vertically by black expansion strips 52. After assembling the folded supports 9, as described in embodiments illustrated by FIGS. 3A-3B and FIGS. 4A-4B, gray connecting strips 51 can be shortened by rolling the gray connecting strips 51 up or joining two separate sections of the grey strips 51 and removing the excess. By doing so the left-right separation folded punch-out support structures 50 can be shortened. The top-bottom separation between the supports 9 can be increased by stretching the black expansion strips 52.

FIG. 5B is a schematic top plan view of another embodiment of a punch out structure 54 for nested square columns with three compressive elements 40. This embodiment utilizes inner, middle, and outer nested square columns 55, 56, 57 and two tensile elements 37, 38. Tensile elements 37 in FIG. 5B correspond with tensile elements 23 in FIG. 2C, and tensile elements 38 in FIG. 5B correspond with tensile elements 21 in FIG. 2C. As illustrated in FIGS. 3A-B and FIGS. 4A-B, all three columns 13 have dashed lines 28 where the punch out structure 54 is folded, and solid lines 30 is where the structure 54 is completely severed from the original foil (not shown). This punch out structure 54 also has weld tabs 32 and optional support/stress tabs 34. The attachment point 36 is just found on the outer column 13. As shown in the embodiment illustrated in FIGS. 4A, this punch out structure 54 utilizes a connection area 49 to connect the tensile elements 38 to the compressive elements 40.

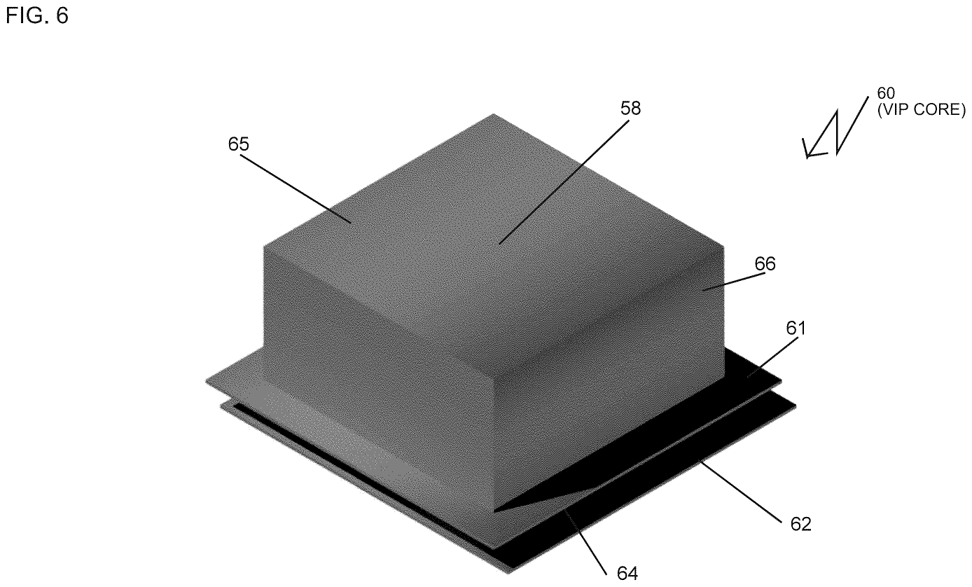

FIG. 6 is a perspective view of a VIP's top foil. The top foil 58 is deformed to fit over the VIP core 60 comprising a plurality of mechanical support structures 9, and the edges 61 make contact with the bottom foil 62. In the embodiment of FIG. 6, the top foil 58 and bottom foil 62 are hermetically sealed together by resistance or laser welding, or by brazing about the perimeter 64. The top foil 58 is deformed so it fits over the top 65 of the core 60 and the sides 66. Other suitable processes to seal the top foil 58 to the bottom foil 62, as known in the relevant art, may also be used.

FIG. 7A is a perspective view of the top and bottom foils 68, 70 of a VIP with shallow trays 72. This figure, in addition to FIG. 7B and FIG. 7C, depicts another method to seal the core 60 (not shown here) comprising a plurality of mechanical supports 9 of the VIP. Here the top and bottom foils 68, 70 form shallow trays 72 that wrap about the top and bottom perimeter of a VIP's core (not shown for visual clarity, but the core would be sandwiched between the two foils 68, 70).

FIG. 7B is a cross-section view of the VIP with corrugations 74 between the top and bottom foils 68, 70. Here the top and bottom foils 68, 70 and their respective trays 72 are wrapped in a thinner (gray) corrugated foil 76. Corrugations 74 in the foil 76 increase the strength of the VIP and lengthen the heat path through the VIP edge to minimize edge losses. An array of VIP supports 9 extending between trays 72 is not shown for visual clarity.

FIG. 7C is a top plan view of an embodiment of the VIP with the top foil 68 removed. In this embodiment, the VIP core 60 is shown exposed with an array of nested square column VIP supports 78 exposed for visual clarity. The nested square column VIP supports 78 were produced using the punch out pattern shown in FIG. 5B. The surrounding foil 76 is still visible on the side of the VIP 80 and can be evacuated through an evacuation channel 82 made by a foil path on the lower left in FIG. 7C, but the evacuation channel 82 can be anywhere about a VIP 80. In combination, FIGS. 7A, 7B, and 7C depict a method to seal the VIP's core 60 utilizing tray style top and bottom foils 68, 70. In FIG. 7C the supports 78 are located against the perimeter, surrounding foil 76 of the VIP to support the VIP's edge which also has an atmospheric load on it.

FIG. 7D is cross-section side view of the VIP 80 with corrugations 74 between the top and bottom foils 68, 70 with a mechanical support 9 and black body radiation shields 83. This figure is the same as FIG. 7B but includes a single mechanical support 9 with black body radiation shields 83 running horizontally to the mechanical support 9. The mechanical support 9 is connected to the top and bottom foils 68, 70 and is representative of an array of mechanical supports (not shown). The two nested square columns were produced using the punch out pattern shown in FIG. 4A. The black body shields 83 extend between the spaced apart array of mechanical supports in a full embodiment. In another embodiment like this figure, the corrugations 74 can make contact with the mechanical support 9 to increase robustness.

FIG. 7E is a cross-section side view of the VIP 80 where the top foil 68 has been replaced by Yttria-stabilized zirconia (YSZ) 84 or other ceramic materials rather than a metal foil, as described previously to increase the high temperature resistance of the VIP in an oxidizing ambient. The ceramic extends down the side of the VIP until it reaches a temperature the edge foil can tolerate without deleterious oxidation, i.e. ~1300° C. for FeCrAl. The ceramic has corrugations 85 wherever the VIP will be exposed to a temperature gradient, between the top and bottom surfaces and possibly across the top surface. An adhesion layer 86 like Titanium or Chromium is evaporated on to the edge 122 of the ceramic followed by a layer 87 to facilitate welding or brazing between the ceramic and the edge foil. There are corrugations 74 between the ceramic and bottom foil 84, 70 with a mechanical support 9 and black body radiation shields 83. This figure is the same as FIG. 7B but includes a single mechanical support 9 with black body radiation shields 83 running horizontally to the mechanical support 9. The mechanical support 9 is connected to the ceramic and bottom foils 84, 70 and is representative of an array of mechanical supports (not shown). The two nested square columns were produced using the punch out pattern shown in FIG. 4A. Additional black body shields 83 are indicated due to black body radiation increasing at higher temperatures (~T⁴). Not shown in figure is metallization on bottom of ceramic top 84 to lower its emissivity.

FIG. 7F is cross-section side view of the VIP 80 with glass panes 89 for the top and bottom surfaces. This is a design for applications requiring a transparent VIP which is also referred to as “vacuum glazing.” An adhesion layer 86 like Titanium or Chromium is evaporated on to the edge of the edge foil followed by an Aluminum layer 87 to facilitate anodically bonding the edge foil to the glass pane 89. There are corrugations 74 in the edge foil with a mechanical support 9. This figure is the same as FIG. 7B but includes a single mechanical support 9. The mechanical support 9 is connected to the glass panes 89, 89 and is representative of an array of mechanical supports (not shown). The two nested square columns were produced using the punch out pattern shown in FIG. 4A.

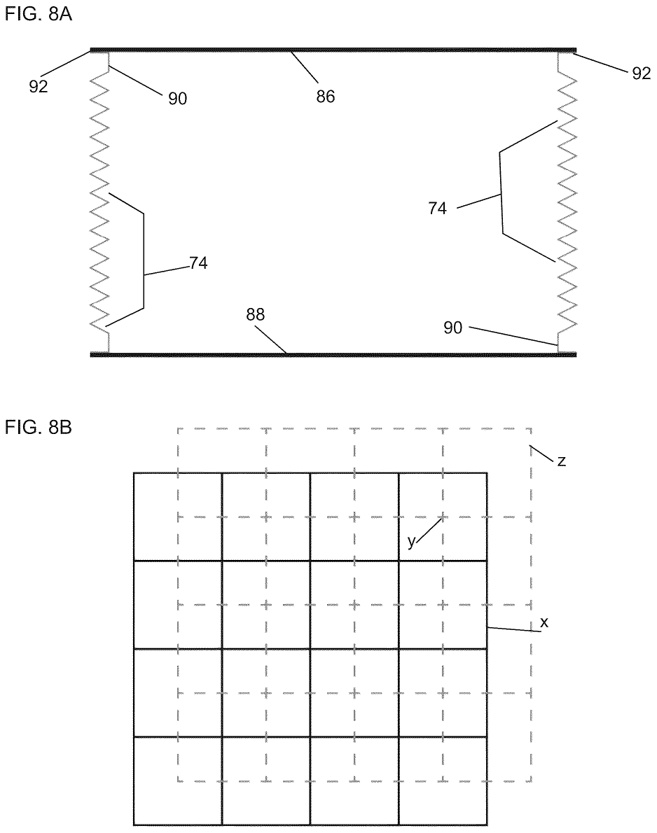

FIG. 8A is a side elevation view of a VIP with a deformed thinner foil 90. Top and bottom foils 86, 88 are shown as thicker black lines. Thinner gray foil 90 is deformed as shown with corrugations. Thinner foil 90 may need to be heated to create the corners 92 as seen in FIG. 7C. Corrugations 74 in foil 90 increase its strength and lengthen the heat path to minimize edge losses. The array of VIP supports is not shown for visual clarity.

The configuration shown in FIG. 8A can be used to form a port hole through the VIP (not shown). Port holes are useful to bring anything into or out of a thermally isolated area. This includes creating a solar thermal battery, using a laser to heat a thermally insulated volume, bringing reactants into and products out of a high or low temperature volume, performing measurements of the thermally isolated area, bringing services, etc. When creating a thermally isolated region the edges of the VIP are locations where there is enhanced heat flow. Minimizing the length of the edge minimizes the heat conduction. In a solar battery for example with a thermal mass that is a 4 foot cube and solar illumination concentrated into a 4 inch circle the ideal situation would be to completely surround the thermal mass with a VIP except where focused sunlight enters. A more practical realization would be to surround the cube with 5 VIPs that are ~4 foot squares and one 4 foot square VIP would have a 4 inch diameter port hole in the middle of it to allow the focused sunlight to strike the thermal mass. Creating the same structure without a porthole might require the same 5 square VIPs and then use 4 rectangular VIPs that are ~22 inches×26 inches arranged to leave a 4 inch square open in the center of the thermal mass.

If the VIPs S_{cross} is small enough, i.e. two inches, then a suit can be created with small VIP tiles X as shown in FIG. 8B. The center Y of each tile can be tethered to an elastic suit (not shown). If one layer of tiles, i.e. indicated by the solid squares of FIG. 8B, does not provide sufficient thermal insulation when the wearer moved, a second layer of these tiles Z could be attached to the suit by again tethering the centers of the second set of tiles, i.e. indicated by the dashed squares in FIG. 8B, to the elastic suit. The second set of tiles covers up most of the gaps in the first set of tiles by being offset by half a square tile in each direction.

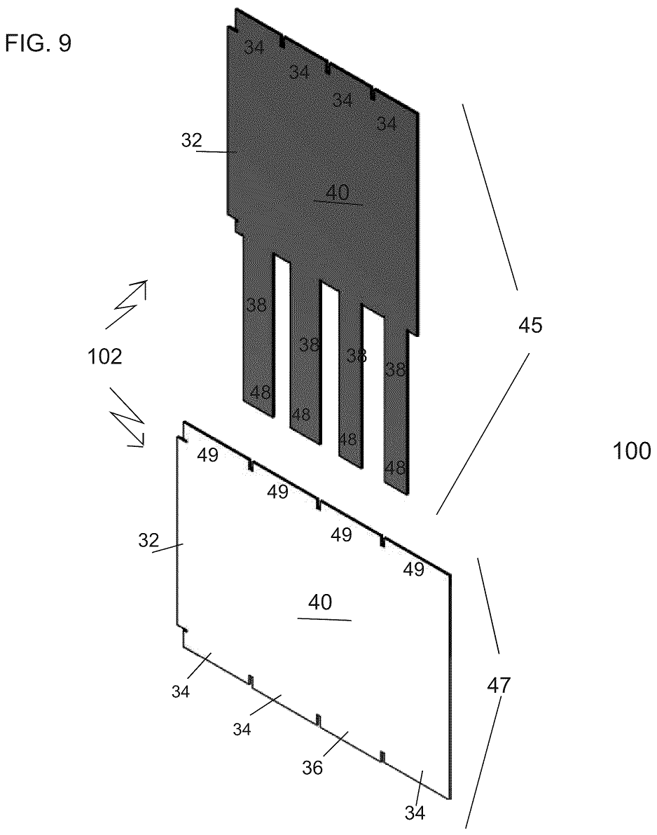

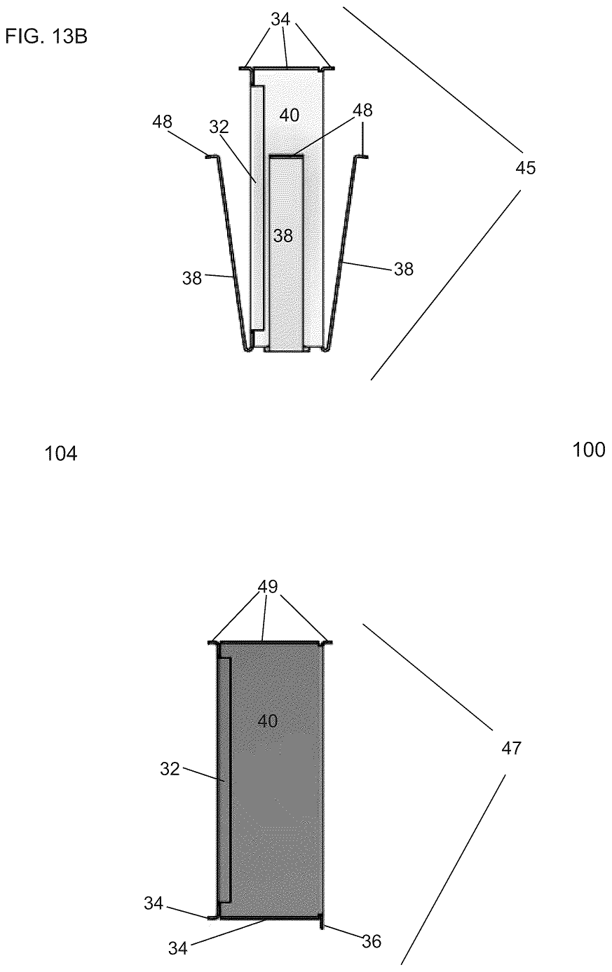

FIGS. 9-13 depict the method as to which a severed punch-out structure 100 is folded from a first flat form 102 to a final fully folded form 104 (FIG. 13). FIG. 9 shows the severed punch-out structure 100 in its first flat form 102. FIG. 9 depicts the three-dimensional assembly of nested square columns with planar tensile elements as depicted in the schematic view of FIG. 4A. The top portion of FIG. 9 depicts what will be the inner column 45 of a compressive element 40 with four tensile elements 38 as part of its structure. The tensile elements 38 each have a connection tab 48 at its respective distal end. At the top of the inner column 45, four support/stress tabs 34 can be seen. On the left portion of the inner column 45, a singular weld tab 32 can be seen running parallel to one side of the compressive element 40. The lower portion of FIG. 9 depicts what will be the outer column 47. In this embodiment, the outer column 47 is comprised of a compressive element 40 with connection areas 49 to receive the tensile elements 38 of the inner column 45. A singular weld tab 32 is used for visual clarity that runs along the left side of the compressive element 40. At the bottom of the outer column 47 are optional support/stress tabs 34 and an attachment point 36. Omitted from this image for visual clarity purposes are the dashed lines 28 (FIGS. 3A, 4A-B, 5B), locating where to fold the structure.

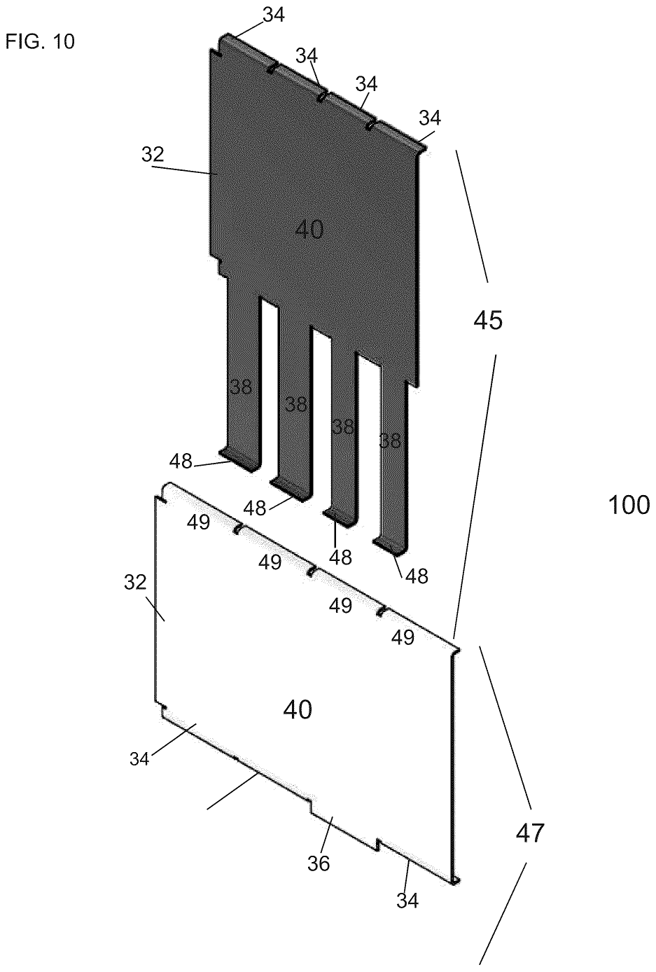

FIG. 10 is a three-dimensional perspective view of a VIP severed punch out structure 100 receiving a first set of folds. As described earlier, the outer column 47 and inner column 45 are folded at different times around their respective mandrels when all the elements of the array are assembled simultaneously. The outer and inner columns 47, 45 can be folded at the same time if only one row or column of the array is assembled at a time. The inner column 45 has a total of eight folds. The first set of folds consists of the upper support tabs 34. The other set of folds are at the lower edge of the tensile elements 38 at the connection tabs 48. The outer column 47 has seven folds. At the top of the outer column 47 the four connection areas 49 are folded in a way to subsequently receive the connection tabs 48. At the bottom of the outer column 47, just the three support tabs 34 are folded. The attachment point 36 remains unfolded. The weld tabs 32 have not been folded in this figure.

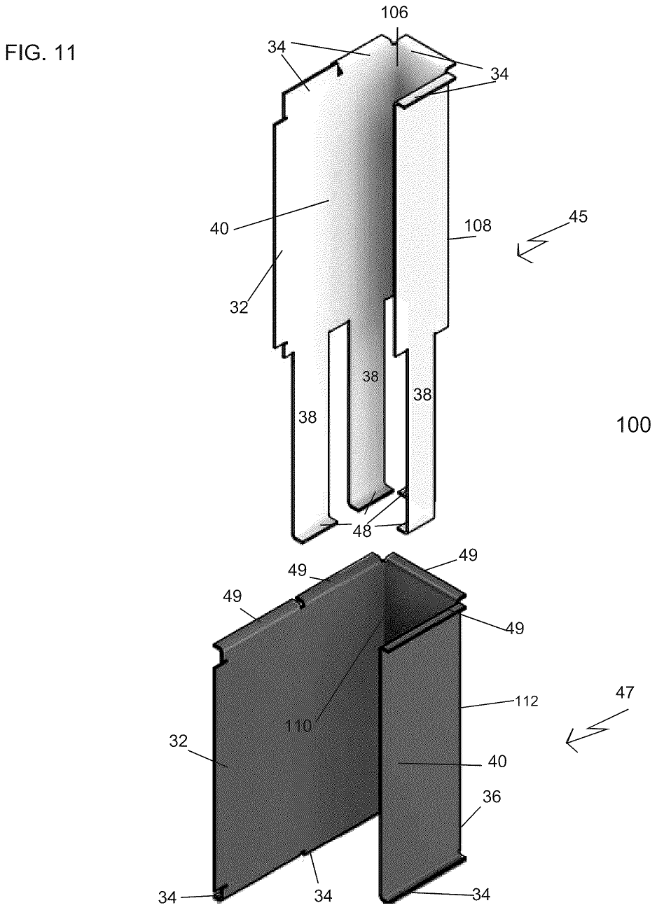

FIG. 11 is a three-dimensional perspective view of a VIP severed punch out structure 100 receiving a second set of folds. The inner column 45 receives a first set of two body folds 106, 108 of the compressive element 40. From these first set of body folds 106, 108 it can be seen that the upper support tabs 34 are folded outwardly away from the inner column's axis 45, and the folds of the lower connection tabs 48 are folded inwardly towards the inner column's axis 45. The outer column 47 receives a first set of two full body folds 110, 112 that extend throughout the full length of the outer column 47 and its compressive element 40. From this first set of two full body folds 110, 112, it can be seen that the connection areas 49 are folded outwardly away from the outer column's axis 47, and the support tab 34 are folded outwardly from the outer column's axis 45. The weld tabs 32 have not been altered in this figure.

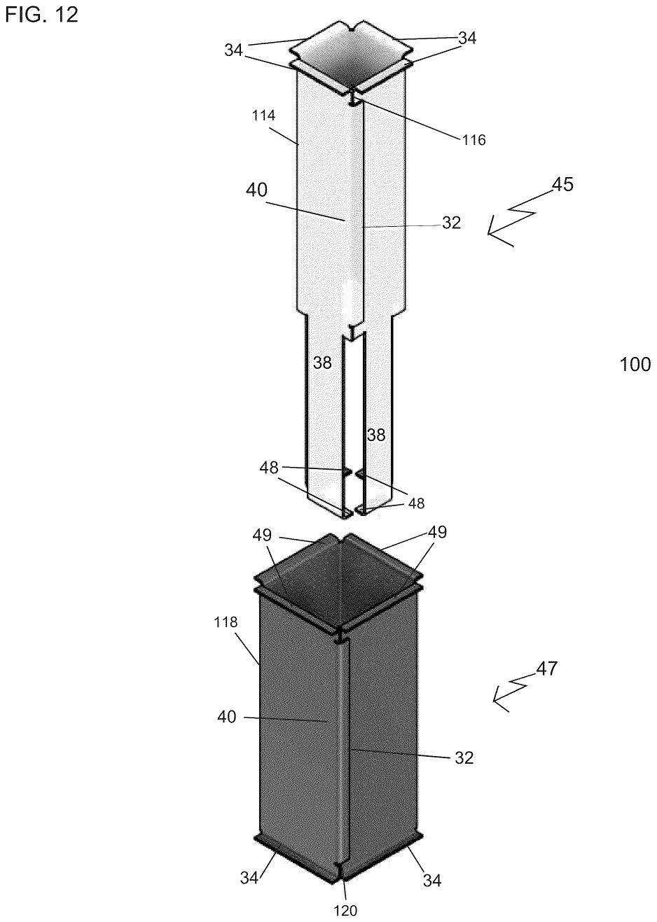

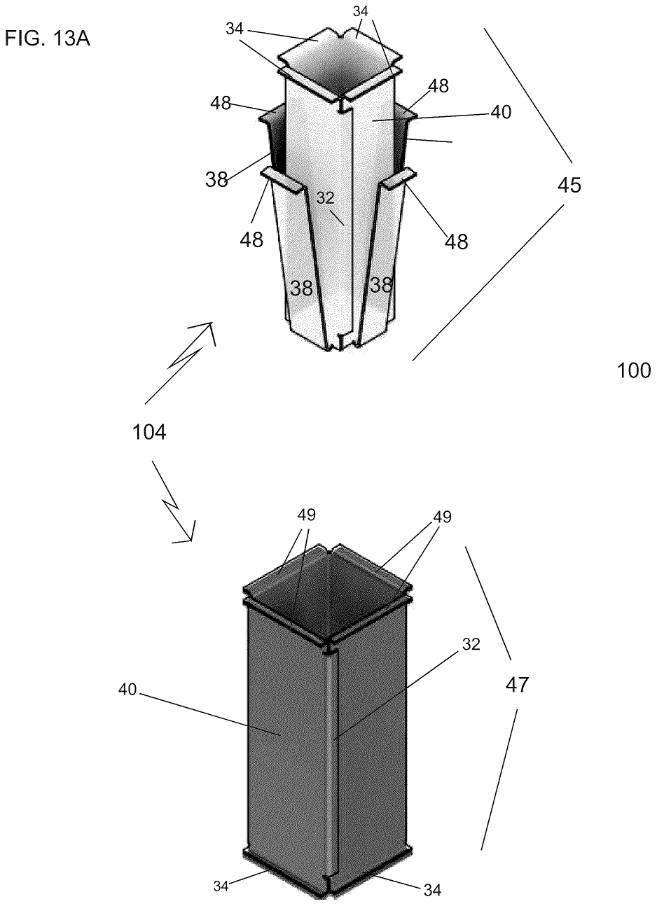

FIG. 12 is a three-dimensional perspective view of a VIP severed punch out structure 100 receiving a third set of folds. The inner column 45 receives a second set of two body folds 114, 116 to the compressive element 40. From these second set of body folds 114, 116 the inner column 45 is formed. The weld tab 32 of the inner column 45 is now folded onto a surface of the compressive element 40 itself. This weld tab 32 of the inner column 45 is welded or brazed to the compressive element 40. The support tabs 34 and the connection tabs 48 remain in the same position as they were in FIG. 11. The outer column 47 receives a second set of two full body folds 118, 120 that extend throughout the full length of the outer column 47 and its compressive element 40. From this second set of two full body folds 118, 120, the outer column 47 is now fully formed. The weld tab 32 of the outer column 47 is folded onto a surface of the body of the compressive element 40 and is connected via welding or brazing. The connection areas 49, the attachment point 36 (not visible from this perspective), and the support tab 34 remain in the same position as they were in FIGS. 10-11.

FIG. 13A is a three-dimensional perspective view of a VIP severed punch out structure 100 receiving a final set of folds. In this figure the structure of the inner column 45 and the outer column 47 remain nearly identical to that of FIG. 12. The only alteration in this figure can be seen on the inner column 45. The tensile elements 38 are each folded where they meet the compressive element 40 at an appropriate angle. The inner column 45 is now in a position to be inserted into the outer column 47, and the connection tabs 48 can mechanically or physically connect to the corresponding connection areas 49 to form a fully formed mechanical support of a VIP, as seen in FIGS. 2B and 7D. The inner column 45 and outer column 47 are now both now in the fully folded form 104.

FIG. 13B is a lateral perspective view of a VIP severed punch out structure 100 receiving a final set of folds. This figure is identical to that of FIG. 13A with the exception of how the severed punch out structure is being viewed 100. From this lateral view the attachment point 36 (not visible in FIG. 13A) is directed downwards. As in FIG. 13A the tensile elements 38 of inner column 45 are each folded where they meet the compressive element 40 at an appropriate angle. The inner column 45 is now in a position to be inserted into the outer column 47, and the connection tabs 48 can mechanically or physically connect to the corresponding connection areas 49 to form a fully formed mechanical support of a VIP, as seen in FIGS. 2B and 7D. The inner column 45 and outer column 47 are now both now in the fully folded form 104. In this figure, and FIGS. 10-13A both the inner and outer column 45, 47 are parallel to the initial sheet used to create the inner and outer columns 45, 47. Upon moving the inner and outer column to 45, 47 to a final assembly position the inner and outer columns 45, 47 will be perpendicular to the initial sheet the inner and outer columns 45, 47 were made from.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural or method elements that do not differ from the literal language of the claims, or if they include equivalent structural elements with insubstantial differences from the literal languages of the claims.

What is claimed:

1. A robust vacuum insulation panel, comprising:
a top foil and a bottom foil spaced apart a predetermined distance;
a core extending between and in contact with a lower surface of the top foil and an upper surface of the bottom foil;
the core comprising an array of mechanical supports, the mechanical supports defining a heat conductivity path between the top foil and the bottom foil;
the array of mechanical supports comprising a plurality of individual mechanical supports;
each individual mechanical support comprising at least two nested compressive elements and at least one tensile element, the at least one tensile element in contact with and extending between the at least two nested compressive elements.

2. The robust vacuum insulation panel of claim 1, wherein:
each individual mechanical support extending between the top foil and the bottom foil, each mechanical support attached to the top foil and the bottom foil.

3. The robust vacuum insulation panel of claim 1, wherein:
each individual mechanical support is one of fastened to the lower surface of the top foil and to the upper surface of the bottom foil, and lodged between the lower surface of the top foil and an upper surface of the bottom foil.

4. The robust vacuum insulation panel of claim 1, wherein:
the pair of at least two nested compressive elements of each individual mechanical support comprises a plurality of nested columns of a predetermined foil material, each column having a top portion and a bottom portion, the top portion of an outer column connected by a tensile element to the bottom portion of an inner column.

5. The robust vacuum insulation panel of claim 4, wherein:
each tensile element is made from the predetermined foil material.

6. The robust vacuum insulation panel of claim 2, wherein:
an exterior foil extends around the vacuum insulation panel, the exterior foil hermetically connected to the top foil and the bottom foil to form a sealed vacuum insulation panel.

7. The robust vacuum insulation panel of claim 2, wherein:
a ceramic layer extends over the top of the vacuum insulation panel; and
an exterior foil comprises the bottom foil.

8. The robust vacuum insulation panel of claim 1, wherein:
the mechanical supports of the core are arranged in a plurality of array shapes.

9. The robust vacuum insulation panel of claim 3, wherein:
each of the at least two nested columns are corrugated.

10. A punch out structure for a robust vacuum insulation panel, the punch out structure forming at least one mechanical support for the vacuum insulation panel, comprising;
a sheet of foil of a predetermined material, the sheet of foil having a punch out structure, the punch out structure having at least one tensile element;
the at least one tensile element configured to support at least the atmospheric load applied to the vacuum insulation panel, the at least one tensile element connecting at least two compressive elements;
the at least two compressive elements comprising an outer and an inner compressive element, each compressive element having a top and a bottom portion;
the at least one tensile element extending between and connecting the top portion of the outer compressive element to the bottom portion of the second compressive element;
the at least one tensile element and the at least two compressive elements transforming from a first flat form to a second constructed form upon changing the configuration of the at least one tensile element and the at least two compressive elements.

11. The punch out structure for a robust vacuum insulation panel of claim 10, wherein each compressive element has at least one weld tab.

12. The punch out structure for a robust vacuum insulation panel of claim 10, wherein:
the at least one tensile element and the at least two compressive elements each have at least one fold line, the at least one fold line indicating where the punch out structure is folded upon configuring the second constructed form.

13. The punch out structure for a robust vacuum insulation panel of claim 10 wherein, each mechanical support has at least one support tab.

14. The punch out structure for a robust vacuum insulation panel of claim 10, wherein a connection tab of the at least one tensile element is configured to connect to a connection area of one of the at least two compressive elements.

15. The punch out structure for a robust vacuum insulation panel of claim 10, wherein:
the at least one tensile element and the at least two compressive elements are connected, the at least one tensile element having a connection tab, and the at least two compression elements each having a connection area configured to receive the connection tab.

16. A punch out structure for a robust vacuum insulation panel, the punch out structure forming at least one mechanical support for the vacuum insulation panel, comprising:
at least one compressive element having a top and a bottom portion;
the at least one compressive element having at least one fold line, the at least one fold line indicating where the compressive element's punch out structure is folded, the compressive element transforming from a first flat form to a second constructed form upon folding the punch out structure on the at least one fold line.

17. A method to produce a mechanical support structure for a robust vacuum insulation panel comprising;
selecting a punch out structure;
placing the punch out structure on a device that can implement a predetermined punch out force;
selecting a foil of a predetermined material to become the mechanical support structure;
punching out the mechanical support structure from a utilized portion of the predetermined foil material;
removing an unutilized punched out foil excess;
folding the utilized punch out foil along predetermined fold lines indicated on the punch out structure; and
attaching weld tabs to the mechanical support structure.

18. The method to produce a mechanical support structure for a robust vacuum insulation panel of claim 17, wherein, a separate inner column and a separate outer column are formed upon folding the utilized punch out foil along the predetermined fold lines indicated on the punch out structure.

19. The method to produce a mechanical support structure for a robust vacuum insulation panel of claim 18, wherein:
the at least one inner column is inserted into the at least one outer column to form one mechanical support.

20. The method to produce a mechanical support structure for a robust vacuum insulation panel of claim 19, wherein:
the at least one inner column and the at least one outer column are adjoined via at least one tensile element.

21. The method to produce a mechanical support structure for a robust vacuum insulation panel of claim 17, wherein:
the mechanical support structure is a nested column structure having at least one planar tensile element and at least two compressive elements.

22. A robust vacuum insulation panel with mechanical support structures comprising:
a core comprised of a three-dimensional array of mechanical support structures constructed from at least one sheet of a foil material, the three-dimensional array of mechanical support structures configured to support at least an atmospheric load upon the vacuum insulation panel, the three-dimensional array of mechanical support structures comprising at least one mechanical support structure constructed from the at least one sheet of foil material;
the at least one mechanical support structure having N number of compressive elements and N−1 number of tensile elements, the N number of compressive elements and the N−1 number of tensile elements configured to minimize heat transfer through the at least one mechanical support structure;
a top foil disposed above the core and a bottom foil disposed below the core; and
a side edge foil attached to the top and bottom foils, the side edge foil hermetically enclosing the sides of the core.

23. The robust insulation panel of claim 1, wherein:
the top foil is deformed and extends completely over the core, with perimeter edges of the top foil in contact with the bottom foil; and
the perimeter edges of the top foil hermetically sealed to the bottom foil by one of resistance welding, laser welding, and brazing.

24. The robust vacuum insulation panel of claim 1, wherein:
the top foil includes a perimeter of downward extending connected flanges, the downward extending flanges forming a first tray;
the bottom foil including a perimeter of upward extending connected flanges, the upward extending flanges forming a second tray, the first and second trays spaced apart the predetermined distance;
at least one corrugated foil strip extending around and connected to the downwardly extending flanges of the top foil and the upwardly extending flanges of the bottom foil.

25. The robust vacuum insulation panel of claim 1, wherein:
an air evacuation channel is in communication with the predetermined space between the top foil and the bottom foil, the air evacuation channel also in communication with a source of vacuum pressure, the source of vacuum pressure adapted to create a vacuum in the predetermined space.

26. The robust vacuum insulation panel of claim 24, wherein:
the predetermined space between the top foil and the bottom foil includes at least one black body radiation shield, the at least one black body radiation shield located among the array of mechanical supports.

27. The robust vacuum insulation panel of claim 1, further including:
at least one strip of corrugated foil attached adjacent to an outer perimeter of the top foil and an outer perimeter of the bottom foil, the strip of corrugated foil surrounding the core.

28. A robust vacuum insulation panel, comprising:
a top foil and a bottom foil spaced apart a predetermined distance,
a core extending between and in contact with a lower surface of the top foil and an upper surface of the bottom foil;
the core comprising an array of spaced apart hollow mechanical supports;
the array of hollow mechanical supports defining a heat conductivity path between the top foil and the bottom foil; and
at least one black body radiation shield extending among the spaced apart hollow mechanical supports.

29. A robust vacuum insulation panel comprising:
a ceramic layer and a bottom foil spaced apart a predetermined distance;
a core extending between a lower surface of the ceramic layer and an upper surface of the bottom foil;
the core comprising an array of mechanical supports, the mechanical supports defining a heat conductivity path between the ceramic layer and the bottom foil;
the array of mechanical supports comprising a plurality of individual mechanical supports;
each individual mechanical support comprising a pair of nested compressive elements and a tensile element, the tensile element in contact with and extending between the nested compressive elements.

30. The robust vacuum insulation panel of claim 29, wherein:
the ceramic layer also comprises a second foil layer located on the bottom surface of the ceramic layer, the core extending between a lower surface of the second foil layer and the top surface of the bottom foil;
the second foil layer forming part of the heat conductivity path.

31. The robust vacuum insulation panel of claim 29, wherein:
the ceramic layer has an edge extending downward from a top of the ceramic layer to a point defined by where the temperature of the edge of the ceramic layer can tolerate a predetermined temperature without deleterious oxidation.

32. The robust vacuum insulation panel of claim 29 wherein:
the ceramic layer comprises Yttria-stabilized zirconia (YSZ).

33. The robust vacuum insulation panel of claim 29, wherein the top ceramic layer includes corrugations.

34. The robust vacuum insulation panel of claim 31, wherein:
the edge of the top ceramic layer is attached to the bottom foil by an adhesion layer, the adhesion layer comprising one of titanium and chromium;
the adhesion layer evaporated to the edge of the edge foil and a layer of aluminum is applied over the adhesion layer;
the ceramic layer attached to the bottom foil by one of welding and brazing.

35. The robust vacuum insulation panel of claim 29, wherein:
the plurality of mechanical supports extends between the ceramic layer and the bottom foil.

36. The robust vacuum insulation panel of claim 29, further including:
a plurality of black body radiation shields extending between the plurality of individual mechanical supports.

37. The robust vacuum insulation panel of claim 29, further including:
a metal layer on a bottom surface of the ceramic layer.

38. A robust vacuum insulation panel, comprising:
a top transparent glass pane and a bottom transparent glass pane spaced apart a predetermined distance;
a core extending between and in contact with a lower surface of the top glass pane and an upper surface of the lower glass panel;
the core comprising an array of mechanical supports, the mechanical supports defining a heat conductivity path between the top glass pane and the bottom glass pane;
the array of mechanical supports comprising a plurality of individual mechanical supports;
each individual mechanical support comprising at least a pair of nested compressive elements and at least one tensile element, the at least one tensile element in contact with and extending between the at least a pair of nested compressive elements.

39. A method for forming a support element for a vacuum insulation panel from a flat foil material, comprising:
severing a predetermined amount of foil from the flat foil material, the predetermined amount of material including weld tabs;
placing a conducting rod of a predetermined cross section over the predetermined amount of foil;
wrapping, using a first actuator initially located below the predetermined amount of foil, the predetermined amount of foil around a lower portion of the conducting rod;
pinching together, using a second actuator, a top part of the predetermined amount of foil over the conducting rod;
attaching together, using one of spot welding and brazing, the weld tabs;
removing the conducting rod.

40. The punch out structure of claim 10, further comprising:
a first connecting strip extending between and attached to a compressive element;
the first connecting strip configured to be shortened by one of coiling the connecting strip upon itself and joining two separate sections of the first connecting strip and removing the excess.

41. The punch out structure of claim 10, further comprising:
an expansion strip connected to each of two adjacent compressive elements;
the expansion strip configured to increase the distance between the mechanical supports.
